(19) United States
(12) Patent Application Publication
(10) Pub. No.: US 2011/0164981 A1
(43) Pub. Date: Jul. 7, 2011

(54) PATTERNED TURBOMACHINE COMPONENT AND METHOD OF FORMING A PATTERN ON A TURBOMACHINE COMPONENT

(75) Inventor: Canan Uslu Hardwicke, Simpsonville, SC (US)

(73) Assignee: GENERAL ELECTRIC COMPANY, Schenectady, NY (US)

(21) Appl. No.: 12/651,817

(22) Filed: Jan. 4, 2010

(51) Int. Cl. F01D 5/22; B05D 5/00; B05D 1/08; B05D 3/06; B05C 5/00; F01D 5/14; B29C 43/00

(52) U.S. Cl. 416/179; 427/256; 427/448; 427/596; 427/555; 118/696; 416/223 R; 264/319

(57) ABSTRACT

A method of forming a pattern on a turbomachine component includes adding material to selected surface regions of the turbomachine component, the material is arranged in a predetermined pattern.

### BACKGROUND OF THE INVENTION

The subject matter disclosed herein relates to the art of turbomachines and, more particularly, to a patterned turbomachine component and a method of forming a pattern on a turbomachine component.

Turbomachine components, such as compressor blades, rotate to generate a high pressure air flow. The high pressure air flow combines with a combustion air flow to rotate turbine blades. Changes in aerodynamic properties of either the compressor blades and/or the turbine blades result in changes to overall operational characteristics of the turbomachine. It has been found that increasing a surface area of compressor and/or turbine blades leads to enhanced turbomachine operation.

Conventional methods of increasing surface area of compressor and/or turbine blades include molding processes and etching or machining, i.e., surface removal, processes. In the molding process, patterns are formed on a mold. When cast, the patterns are formed on a surface of the compressor and/or turbine blades. The patterns are configured and disposed to increase an effective surface area and enhance aerodynamic properties of the compressor and/or turbine blades. In the etching process, chemicals, lasers or other methods are employed to remove specific portions from the surface of the compressor and/or turbine blades. As noted above, the patterns are configured and disposed to increase an effective surface area and enhance aerodynamic properties of the compressor and/or turbine blades.

### BRIEF DESCRIPTION OF THE INVENTION

According to one aspect of the invention, a method of forming a pattern on a turbomachine component includes adding material to selected surface regions of the turbomachine component, the material is arranged in a predetermined pattern.

According to another aspect of the invention, a turbomachine component includes a body portion having an external surface. A pattern is formed on the external surface. The pattern includes material added to the external surface through a direct write (DW) process.

System and computer program products for adding material to selected regions of a turbomachine component are also described and claimed herein.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial, cross-sectional view of a turbomachine including a patterned turbomachine component in accordance with an exemplary embodiment;

FIG. 2 is a perspective view of the patterned turbomachine component of FIG. 1;

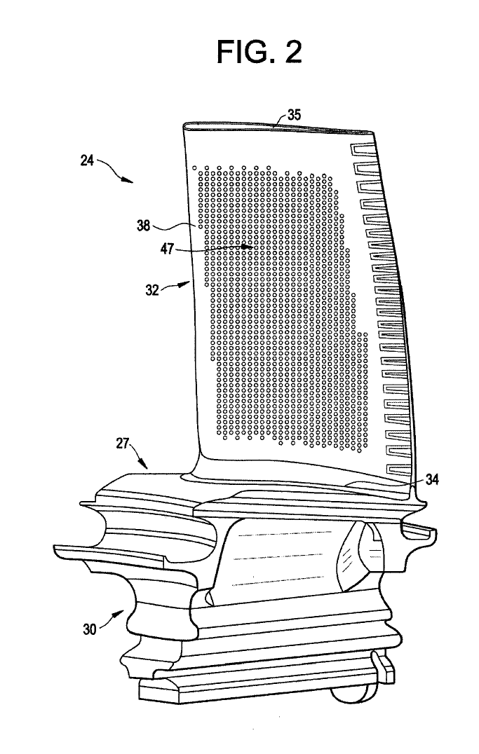

FIG. 3 is a partial side view of the patterned turbomachine component of FIG. 2 illustrating material added to a surface of the turbomachine component to form a pattern;

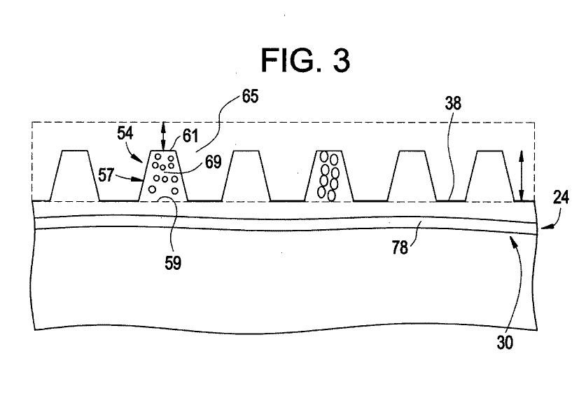

FIG. 4 is a flow chart illustrating a method of forming a pattern on a turbomachine component in accordance with an exemplary embodiment; and

FIG. 5 is a plan view of another patterned turbomachine component in accordance with an exemplary embodiment.

The detailed description explains embodiments of the invention, together with advantages and features, by way of example with reference to the drawings.

### DETAILED DESCRIPTION OF THE INVENTION

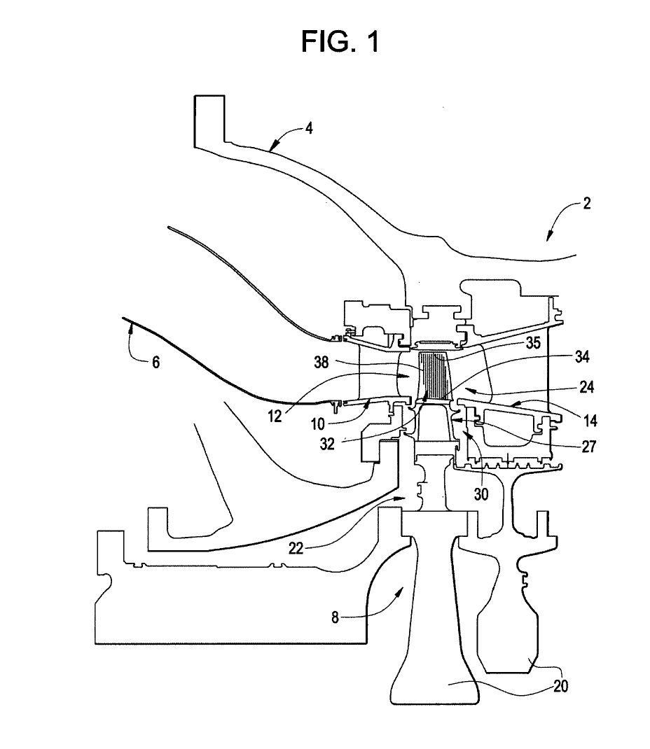

Referring to FIG. 1, a turbomachine constructed in accordance with an exemplary embodiment is indicated generally at 2. Turbomachine 2 includes a turbine casing 4 that houses a combustion chamber 6 and a turbine stage 8. In the exemplary embodiment shown, turbine stage 8 is a first stage. Combustion gases from combustion chamber 6 pass through a first stage nozzle 10 along a hot gas path (HGP) 12 to a second stage nozzle 14. The combustion gases drive a rotor disk 20 that, in turn, drives a turbine shaft (not shown). Rotor disk 20 is arranged in a wheel space area 22 of turbomachine 2 and includes a plurality of turbine buckets, one of which is indicated at 24, mounted to rotor disk 20. Each turbine bucket 24 includes a body portion 27 that defines a base portion 30, and an airfoil portion 32. Airfoil portion 32 includes a first end section 34 that extends to a second end section 35 through an airfoil surface 38. The combustion gases passing along hot gas path 12 impact airfoil surface 38 pushing airfoil portion 32 circumferentially causing rotor disk 20 to rotate.

In accordance an exemplary embodiment, airfoil surface 38 includes a patterned zone 47 having a plurality of raised elements, one of which is indicated at 54 that enhance aerodynamic performance for turbine bucket 24. Each raised element 54 includes a body portion 57 having a base portion 59 that extends to a tip portion 61. Although shown having a generally trapezoidal form with base portion 59 being larger than tip portion 61, it should be understood that raised element 54 can take on a variety of forms, including forms having rectangular profiles, curvilinear profiles and the like. In accordance with one aspect of the exemplary embodiment, a coating is applied to patterned zone 47. Coating 65 provides additional protection for each raised element 54. In the exemplary embodiment shown, coating 65 is applied in a substantially linear layer. However, it should be understood that coating 65 could also be contoured. In accordance with another aspect of the exemplary embodiment, a plurality of pores 69 are created in body portion 57. Pores 69 further enhance the surface area of raised elements 54.

In further accordance with the exemplary embodiment, patterned zone 47 is formed using a direct right (DW) process. The direct right process adds material to airfoil surface 38 in a predetermined pattern. In accordance with one aspect of the exemplary embodiment, raised elements 54 are formed from at least one of a polymer, a ceramic, a metal, and a composite. Of course other materials and composites may also be employed. As will be discussed more fully below, depending upon the material employed for raised elements 54, prior to adding patterned zone 47, a bond coat 78 is applied to airfoil surface 38. Bond coat 78 enhances adhesion of the plurality of raised features 54 that are added using the DW process.

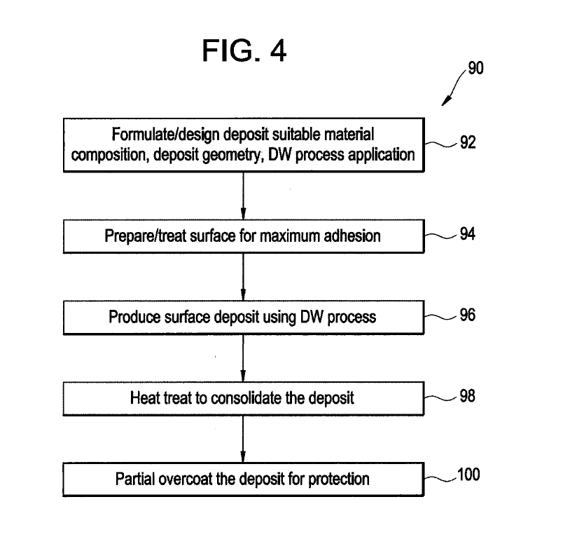

Reference will now be made to FIG. 4 in describing a method 90 of creating patterned zone 47. Initially, a pattern design and material type is formulated for the DW process as indicated in block 92. That is, prior to creating patterned zone 47, the particular type of pattern and the particular material employed to form the pattern is formulated and input into a DW process application. In accordance with one aspect, the particular material(s) chosen will result in raised elements 54 including pores 69. At this point, if required, bond coat 78 is added to airfoil surface 38 as indicated in block 94. After applying bond coat 78 and/or grit blasting or chemical etching is applied to improve surface roughness to enhance adhesion, surface deposits are added to airfoil surface 38 as indicated in block 96. After adding the surface deposits to form the plurality of raised features 54, airfoil surface 38 is heat-treated to consolidate or harden raised features 54 as indicated in block 98. Of course, it should be understood that the need for heat-treatment is dependent upon the particular type of material used in forming the plurality of raised features.

After heat-treating, a partial overcoat is applied to the plurality of raised features 54 as indicated in block 100. The overcoat or coating is used to provide additional protection to the plurality raised features as indicated above. Of course the need for an overcoat or coating is also dependent on a particular type of material used in forming patterned zone 47. In addition to adding features, material may be removed to form additional patterns in airfoil surface 48. The material is removed using one or more known techniques such as etching, lasers and the like.

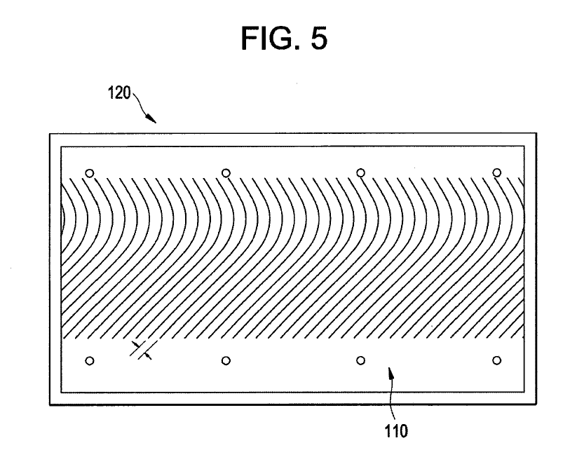

At this point, it should be understood that the exemplary embodiments employs a direct write (DW) process to add material to surface portions of a turbomachine component to form a patterned zone. Of course, once added, portions of the material can be selectively removed to alter/adjust the patterned zone. If desired, the material is selectively removed using a solvent to dissolve portions of the patterned zone, or using a laser to remove/alter portions of the patterned zone. In addition to providing patterns on three-dimensional (3D) surfaces such as turbine buckets described above, exemplary embodiments can be employed to create a patterned zone 110 on two-dimensional (2D) surfaces such as a shroud 120 shown in FIG. 5. Regardless of the surface, the additional material enhances the structural stability of the turbomachine component. That is, instead of the conventional process for creating patterns on existing turbomachine components which requires removing material, the exemplary embodiments add material to the turbomachine component to enhance aerodynamic properties.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of forming patterns on a turbomachine component, the method comprising:
adding material to selected surface regions of the turbomachine component using a direct write (DW) process, the material being arranged in a predetermined pattern.

2. The method of claim 1, wherein adding material to the selected surface regions includes adding at least one of a two-dimensional structure and a three-dimensional structure to the selected surface regions.

3. The method of claim 1, further comprising: creating a computer drawing file that defines the predetermined pattern to be added to the selected surface regions of the turbomachine component.

4. The method of claim 3, further comprising: transferring the pattern directly to the turbomachine component.

5. The method of claim 1, further comprising: adding material with at least one of a nozzle dispensing process, thermal spray process, a soft lithography process, and a laser process.

6. The method of claim 1, further comprising: removing a portion of the material added to the selected surface regions.

7. The method of claim 6, wherein removing the portion of the material includes dissolving, with a laser, predetermined portions of the material.

8. The method according to claim 1, wherein the material is added to select surface regions of one of a compressor blade and a turbine blade.

9. A system for establishing a pattern on a turbomachine component, the system comprising:
a central processing unit (CPU), said CPU being interconnected functionally via a system bus to:
at least one memory device thereupon stored a set of instructions which, when executed by the CPU, causes the system to:
add material to selected surface regions of the turbomachine component using a direct write (DW) process, the material being arranged in a predetermined pattern.

10. The system according to claim 9, wherein the set of instructions, when executed by the CPU, causes the system to: add at least one of a two-dimensional structure and a three-dimensional structure to the selected surface regions.

11. The system according to claim 9, wherein the set of instructions, when executed by the CPU, causes the system to: transfer a pattern stored in the at least one memory device directly to the turbomachine component.

12. The system according to claim 9, wherein the set of instructions, when executed by the CPU, causes the system to: add material through a direct write (DW) process.

13. The system according to claim 12, wherein the set of instructions, when executed by the CPU, causes the system to: add material with at least one of a nozzle dispensing process, miniature gun thermal spray process, a soft lithography process, and a laser process.

14. The system according to claim 9, wherein the set of instructions, when executed by the CPU, causes the system to: remove a portion of the material added to the selected surface regions.

15. A turbomachine component comprising:
a body portion including an external surface; and
a pattern formed on the external surface, the pattern including material added to select portions of the external surface through a direct write (DW) process.

16. The turbomachine according to claim 15, further comprising:
removing a portion of the material added to the select portions of the external surface.

17. The turbomachine according to claim 15, wherein the turbomachine component includes a three-dimensional (3D) surface.

18. The turbomachine according to claim 17, wherein the turbomachine component is one of a compressor blade and a turbine blade.

19. The turbomachine according to claim 15, wherein the turbomachine component includes a two-dimensional (2D) surface.

20. The turbomachine according to claim 19, wherein the turbomachine component is a shroud.
